(19) United States
(12) Patent Application Publication
(10) Pub. No.: US 2008/0046738 A1
(43) Pub. Date: Feb. 21, 2008

(54) ANTI-PHISHING AGENT

(75) Inventors: Michael Galloway, Sunnyvale, CA (US); Bryan Mayes, San Francisco, CA (US); Miles Libbey, Mountain View, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/462,665

(22) Filed: Aug. 4, 2006

(51) Int. Cl. H04L 9/00

(52) U.S. Cl. 713/176

(57) ABSTRACT

A phishing detection agent is provided. In one embodiment, a user's browser includes a plug-in application or agent that may capture a visual record of a webpage and, with a cached copy of known, authentic websites provided to it via periodic updates, perform a series of image comparison functions to determine if the suspected website is attempting to deceive the user. The phishing detection agent is capable of performing an image recognition algorithm, such as logo recognition algorithm, optical character recognition, an image similarity algorithm, or combination of two or more of the above. If the suspected webpage corresponds to one of the authentic web pages, but the domain name of the suspected web page does not match the domain name of one of the authentic web pages, the suspected web page is flagged as a phishing web site.

### FIELD OF THE INVENTION

The present invention relates generally to communicating messages over a network, and in particular but not exclusively, to an apparatus and method for employing an image recognition algorithm to identify counterfeit web pages.

### BACKGROUND OF THE INVENTION

A major type of internet fraud today is known as phishing. Phishing typically involves the practice of obtaining confidential information through the manipulation of legitimate users. Typically, the confidential information is a user's password, credit card details, social security number, or other sensitive user information. Phishing may be carried out by masquerading as a trustworthy person, website, or business. In one approach, a message, such as an email or instant message, may be sent to an unsuspecting user. The message may include a link or other mechanism that links to an illegitimate source. In another approach, a webpage that may appear to be legitimate is provided to the user. However, the webpage is designed to trick the user into providing their confidential information. Such webpages may relate to account log-in sites, credit card entry sites, or the like.

The false site typically contains a request for the individual's password, credit card, social security number, or other personal information. This information, if given by the individual, is then submitted to the person posing as the bank or popular website. Once the unsuspecting user enters their information, the phisher may be able to obtain the sensitive information and use it to create fake accounts in a victim's name, ruin the victim's credit, make purchases under the victim's name, sell the information to others, perform acts under the victim's identity, or even prevent the victim from accessing their own money and/or accounts.

As the rise internet usage continues, phishing scams have become increasingly popular across the internet. Some estimates place the number of users affected in the millions and the amount of damage to businesses in the billions. As this problem is only increasing, an effective solution is desperately needed to sustain the necessary user trust that is required for continual growth in the ecommerce sector of our economy.

### BRIEF DESCRIPTION OF THE DRAWINGS

Non-limiting and non-exhaustive embodiments of the present invention are described with reference to the following drawings, in which:

FIG. 1 shows a block diagram of an embodiment of a system for communicating over a network;

FIG. 2 illustrates one embodiment of a client device that may be included in a system implementing an embodiment of the invention;

FIG. 3 shows one embodiment of a network device that may be included in a system implementing an embodiment of the invention;

FIG. 4 illustrates an embodiment of the web page that may be subject to phishing detection according to one embodiment of the invention;

FIG. 5 shows a flowchart of an embodiment of a process;

FIG. 6 shows a flowchart of an embodiment of another process; and

FIG. 7 illustrates a flowchart of an embodiment of yet another process, in accordance with aspects of the present invention.

### DETAILED DESCRIPTION OF THE INVENTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based, in part, on”, “based, at least in part, on”, or “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Briefly stated the invention is related to a phishing detection agent. In one embodiment, a user's browser includes a plug-in application or agent that may capture a visual record of a webpage and, with a cached copy of known, authentic websites provided to it via periodic updates, perform a series of image comparison functions to determine if the suspected website is attempting to deceive the user. The phishing detection agent is capable of performing an image recognition algorithm, such as logo recognition algorithm, optical character recognition, an image similarity algorithm, or combination of two or more of the above. If the suspected webpage corresponds to one of the authentic web pages, but the domain name of the suspected web page does not match the domain name of one of the authentic web pages, the suspected web page is flagged as a phishing web site.

### Illustrative Operating Environment

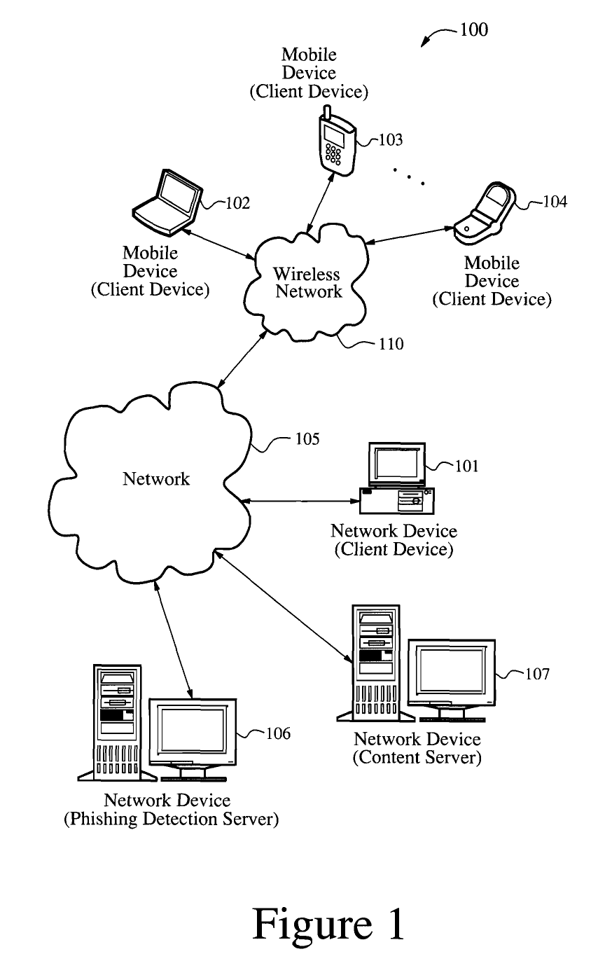

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes network 105, wireless network 110, Phishing Detection Server (PDS) 106, mobile devices (client devices) 102-104, client device 101, and content server 107.

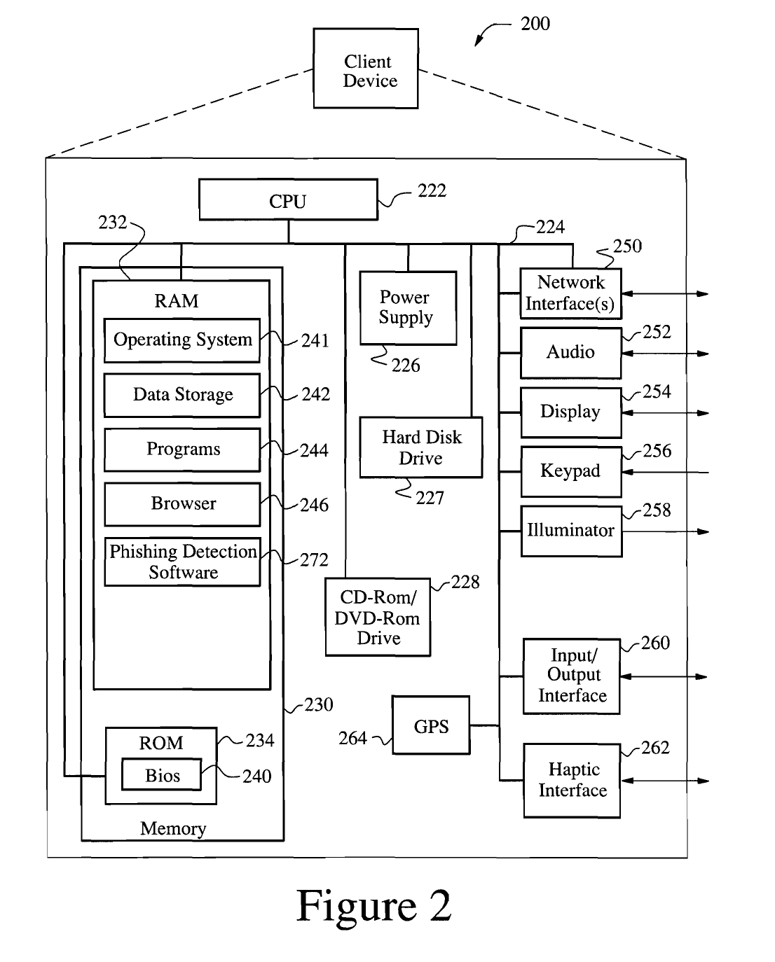

One embodiment of client devices 101-104 is described in more detail below in conjunction with FIG. 2. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 102-104 also may include at least one other client application that is configured to receive content from another computing device. The client application may include a capability to provide and receive textual content, graphical content, audio content, and the like. The client application may further provide information that identifies itself, including a type, capability, name, and the like. In one embodiment, mobile devices 102-104 may uniquely identify themselves through any of a variety of mechanisms, including a phone number, Mobile Identification Number (MIN), an electronic serial number (ESN), or other mobile device identifier. The information may also indicate a content format that the mobile device is enabled to employ. Such information may be provided in a message, or the like, sent to PDS 106, client device 101, or other computing devices. Moreover, mobile devices 102-104 may further provide information associated with its physical location to another computing device.

Mobile devices 102-104 may also be configured to communicate a message, such as through Short Message Service (SMS), Multimedia Message Service (MMS), instant messaging (IM), internet relay chat (IRC), Mardam-Bey's IRC (mIRC), Jabber, and the like, between another computing device, such as PDS 106, client device 101, or the like. However, the present invention is not limited to these message protocols, and virtually any other message protocol may be employed.

Mobile devices 102-104 may be further configured to enable a user to participate in communications sessions, such as IM sessions. As such, mobile devices 102-104 may include a client application that is configured to manage various actions on behalf of the client device. For example, the client application may enable a user to interact with the browser application, email application, IM applications, SMS application, and the like.

Client device 101 may include virtually any computing device capable of communicating over a network to send and receive information. The set of such devices may include devices that typically connect using a wired or wireless communications medium such as personal computers, multiprocessor systems, microprocessor-based or programmable consumer electronics, network PCs, or the like. Moreover, client device 101, although representing a computing device that is non-mobile, may be configured to perform many of the actions described above for mobile devices 102-104. In addition, in at least one embodiment, client device 101 may also provide information, such as a MAC address, IP address, or the like, useable to determine its physical location.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as mobile devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile devices 102-104 and another computing device, network, and the like.

Network 105 is configured to couple PDS 106 and its components with other computing devices, including, mobile devices 102-104, client device 101, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between PDS 106, client device 101, and other computing devices.

Additionally, communication media typically embodies computer-readable instructions, data structures, program modules, or other data in a modulated data signal such as a carrier wave, data signal, or other transport mechanism and includes any information delivery media. The terms “propagated signal”, “modulated data signal”, and “carrier-wave signal” each include a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Although FIG. 1 illustrates PDS 106 as a single computing device, the invention is not so limited. For example, one or more functions of PDS 106 may be distributed across one or more distinct computing devices.

Content server 107 represents a variety of service devices that may provide additional information for use in client devices 101-104. Such services include, but are not limited to web services, third-party services, audio services, video services, email services, IM services, SMS services, VoIP services, calendaring services, photo services, or the like. Devices that may operate as content server 107 include personal computers desktop computers, multiprocessor systems, microprocessor-based or programmable consumer electronics, network PCs, servers, and the like. In one embodiment, content server 107 includes a web server. Content server 107 may be a separate device from PDS 106, or the same device as PDS 106.

A client device (e.g. 101-104) may include a browser. The browser may be configured to receive and to send web pages, web-based messages, and the like. Browser 246 may, for example, receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like. In one embodiment, a browser in client device 101-104 may be used to load a web page from content server 107, for example by providing a URL (Uniform Resource Locator) for a web page or a link to a URL. The web page may be legitimate, or may instead be counterfeit (e.g. part of a phishing scam). In accordance with aspects of the invention, the client device (e.g. 101-104), PDS 106, and/or a combination of the client device, PDS 106, and/or other network devices acting together, may be used to determine whether a web page loaded by the browser is legitimate. In one embodiment, the identification of whether a web page is counterfeit may be accomplished with a browser plug in application or agent, which can be downloaded (e.g. from server device 106 or the like), and updated incrementally (e.g. through service device 106 or the like). In other embodiments, the determination may be made solely by an application at the client device, or solely by an application at the server device.

### Illustrative Client Device

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. As shown in the figure, client device 200 includes a processing unit 222 in communication with a mass memory 230 via a bus 224.

One embodiment of client device 200 also includes a power supply 226, one or more network interfaces 250, an audio interface 252, a display 254, a keypad 256, an illuminator 258, an input/output interface 260, a haptic interface 262, and a global positioning systems (GPS) receiver 264. However, various embodiment of client device 200 may include more or less components than illustrated in FIG. 2. For example, one embodiment of client device 200 does not include illuminator 258, haptic interface 262, or GPS 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP (Session Initiated Protocol), RTP (Real-Time Transport Protocol), UMTS (Universal Mobile Telecommunications System), and the like.

Audio interface 252 may be arranged to produce and receive audio signals such as the sound of a human voice, music, or the like. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Client device 200 may further include additional mass storage facilities such as CD-ROM/DVD-ROM drive 228 and hard disk drive 227. Hard disk drive 227 is utilized by client device 200 to store, among other things, application programs, databases, and the like. Additionally, CD-ROM/DVD-ROM drive 228 and hard disk drive 227 may store audio data, or the like.

Keypad 256 may comprise any input device arranged to receive input from a user (e.g. a sender). For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, and the like. Haptic interface 262 may be arranged to provide tactile feedback to a user (e.g. a sender) of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS and the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® operating system. The operating system may include an interface with a Java virtual machine module that enables control of hardware components and/or operating system operations via Java application programs.

In one embodiment, operating system 241 may include specialized digital audio mixing, analog audio mixing, and/or audio playing software. Operating system 241 may provide this software through functional interfaces, APIs, or the like. In one embodiment, digital audio mixing may include generating a new playable data that is based on a plurality of playable data input, where the new data may represent a superposition of the audio signals associated with the plurality of playable data input. Digital audio mixing may be enabled by operating system 241 through an API, such as Windows Driver Media (WDM) mixing APIs and/or digital mixing software libraries, such as Windows' DirectSound, FMOD, Miles Sound System, Open Sound System (OSS), SDL Mixer, CAM (CPU's audio mixer), or the like. In one embodiment, stereophonic (stereo) audio data may be converted into mono-audio data to be played over a mono-audio device, or the like. Similarly, analog audio mixing may be enabled by APIs to convert digital data into an analog signal (e.g. modulation), add and/or filter several analog signals, and re-convert the analog signal into digital data. In one embodiment, the addition and/or filtering may be performed by a summing amplifier.

Memory 230 further includes one or more data storage 242, which can be utilized by client device 200 to store, among other things, programs 244 and/or other data. For example, data storage 242 may also be employed to store information that describes various capabilities of client device 200. The information may then be provided to another device based on any of a variety of events, including being sent as part of a header during a communication, sent upon request, and the like.

In one embodiment, programs 244 may include specialized audio mixing and/or playing software. Programs 244 may provide this software through functional interfaces, APIs, or the like. Programs 244 may also include computer executable instructions which, when executed by client device 200, transmit, receive, and/or otherwise process messages (e.g., SMS, MMS, IM, email, and/or other messages), audio, video, and enable telecommunication with another user of another client device. Other examples of application programs include calendars, contact managers, task managers, transcoders, database programs, word processing programs, spreadsheet programs, games, CODEC programs, and so forth. In addition, mass memory 230 stores browser 246 and phishing detection application 272.

Browser 246 may be configured to receive and to send web pages, web-based messages, and the like. Browser 246 may, for example, receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like.

Although not shown, client device 200 may also be configured to receive a message from another computing device, employing another mechanism, including, but not limited to email, Short Message Service (SMS), Multimedia Message Service (MMS), internet relay chat (IRC), mIRC, and the like.

Phishing detection application 272 is configured to enable a determination as to whether a web page loaded by browser 246 is legitimate. In one embodiment, phishing detection application 272 is a browser plug-in. However, the invention is not so limited, and a variety of different configurations may be employed. For example, in one embodiment, phishing detection application 272 is integrated with an email client, or the like.

In one embodiment, the phishing detection application 272 is configured to operate as follows. Image information of at least one image of at least a portion of one or more authenticated web pages is stored, e.g. in client device 200 and/or in PDS 106 of FIG. 1. At least one web page identifier (e.g. the domain name) of each of the authenticated web pages is also stored, e.g. in client device 200 and/or in PDS 106 of FIG. 1. For example, image information may contain reference image(s), which are only authentic on web sites with that domain name of the authenticated web site, or web sites with a domain name that is owned by the same company. Those domain names are authenticated for the reference image(s).

If browser 246 loads a web page, e.g. from content server 107 of FIG. 1, phishing detection application 272 may be employed to determine whether the web page is counterfeit. In one embodiment, phishing detection application 272 checks every web page. In other embodiments, only certain web pages are checked. In different embodiments, different criteria may be used to determine whether to check a web page. In some embodiments, web pages with dialog boxes are checked, and other pages are not checked. Also, if the web page loaded by the browser is on a “blacklist” of sites already identified as phishing sites, phishing detection application 272 may provide an indication that the web page is counterfeit without performing any image recognition. Also, if the domain name of the web page loaded by the browser is one of the authenticated domain names, phishing detection application 272 may determine that the web page is authentic without performing image recognition. Additionally, in one embodiment, web pages in the favorites of the browser 246 are also considered authentic by phishing detection application 272, and therefore these web pages are not checked by phishing detection application 272 in this embodiment. These criteria and others may be used to determine whether to employ phishing detection application 272 to determine whether the web page is counterfeit.

As part of the phishing detection process, phishing detection application 272 may capture an image snapshot of at least a portion of the browser screen. An image recognition algorithm may be performed based on the stored image information and the image snapshot. The image recognition algorithm determines whether the image snapshot “corresponds to” the stored image information. “Corresponds to” does not require an exact match, but a relative equivalency as determined by the image recognition algorithm. If the image snapshot corresponds to the stored image information, and the web page identifier of the web page in the browser is not authenticated for the matched image, phishing detection application 272 determines that the web page is counterfeit, and provides an indication that the web page is counterfeit. For example, in one embodiment, phishing detection application 272 notifies the user via a window, or “pop-up” displaying the results of the discovery. At this point, the user is allowed to close the pop-up and continue using the page, or is allowed to report the find to a maintained archive of potential phishing sites, allowing for human review for inclusion into an archive of verified phishing sites. In one embodiment, the web site is added to the “blacklist” of web sites discussed above.

In one embodiment, a database of known websites likely to be phished (e.g. ebay.com) are maintained. These are the authenticated websites, for which image information is stored. The image recognition algorithm determines whether the web site loaded by the browser corresponds to the image information stored for the authenticated web sites.

In one embodiment, phishing detection application 272 determines the domain name of the web site by parsing the URL of the web page loaded by the browser. In various embodiments, checking the domain name may be done after the image recognition, or before.

For example, in one embodiment, prior to performing image recognition, phishing detection application 272 checks the domain name of the web page loaded by the browser against the domain names in the database of authenticated web sites. If the domain name is in this list, the web page is determined to be authentic, and no image recognition is performed. If the domain name is not in this list, an image recognition algorithm is performed. If there is a match, the web page is identified as counterfeit, since it has already been determined that the web page does not have a domain name in the list of authenticated web sites.

In another embodiment, the image recognition algorithm is performed first. If there is a match, the domain name is checked to see if it is the same as the domain name for the matched image, or a domain name owned by the same company. If not, the web page is identified as counterfeit.

In various embodiments, the image recognition algorithm may be performed in different ways. In one embodiment, the image recognition algorithm is a logo recognition algorithm. In another embodiment, the image recognition algorithm is an optical character recognition (OCR) algorithm, In another embodiment, the image recognition algorithm is an image similarity algorithm. In other embodiments, the image recognition algorithm may be a combination of two or more of a logo recognition algorithm, optical character recognition algorithm, and an image similarity algorithm. For example, in one embodiment, all three types of algorithms and/or other algorithms are performed, and an aggregate score is used to determine whether there is a match. Image similarity algorithms may include page layout, color histograms, and other image similarity criteria. By using color histograms, a web site with a similar color histogram but different colors are still identified as being similar. Also, the data used by the image recognition algorithm can be fine-tuned by training it using actual phishing sites.

A phisher can circumvent conventional detection methods by masking their true intentions using encoded JavaScript, non-printable characters, or other means of hiding. In contrast, phishing detection application 272 attacks the problem of identifying phishing scams from the point of view of the user. What the user sees the system will see. This applies the approach humans use of looking at key visual characteristics of a page. This makes obfuscating the scam from the detection system much more difficult to the phisher since to hide the content from phishing detection application 272 would cause the person they are trying to phish also not to see the content.

### Example Logo Recognition Embodiment

In one logo recognition embodiment, a list of reference images is collected. These images are made up of logos or uniquely identifiable graphics from the sites to be protected. In this embodiment, the “stored image information” includes these reference images. Instead of logos or unique images, sections of a page could also be sampled and stored. An example of a section of a page according to one embodiment is a box defined by the upper left 50×50 pixels of a page. The reference images collected has meta data which describes the page which the image was originally extracted.

To identify if a site is a phishing site or the real site the following procedure happens in one embodiment:
The phishing detection application takes an image snapshot of the browser screen. The sampling could be of the whole image in the browser screen, or a sampling of image areas in a page.
This snapshot or snapshots is then scanned using computer vision (image) algorithms looking for the reference images.
If the reference image is found in the snapshot or one or more of the snapshots, there is a match.
When there is a match, the domain name the page was loaded from is compared the domain name of the page with the domain name in the reference image's meta data. If the domain names do not match, the site is identified as a phishing site.

### Example Optical Character Recognition Embodiment

In one OCR embodiment, the stored image information is a database of known web sites signatures. To create this dataset each web page is loaded and rendered in a browser or browser equivalent. An image capture is taken, for example, of the upper left portion of the page in one embodiment. This image is then run through an OCR filter and all the words are captured out of the image. Extra pieces of data gathered about the captured words are the position within that pixel matrix where the word was found (center of the bounding box) and the size (bounding box height and width) of the captured text. This data is then processed to create a unique signature of the page.

To identify if a site is a phishing site or not the following procedure is performed in one embodiment:
the phishing detection application takes an image snapshot of a portion of the screen displayed by the browser (e.g., the upper left portion in one embodiment).
This snapshot is then processed using computer vision (image) algorithms to extract the text characters (such as OCR).
A signature is calculated using the same algorithm that was used to previously create reference signatures. The calculated signature is then compared to those in a dataset of reference signatures. Algorithms are applied to determine if there is a signature that corresponds to that of the calculated signature.
When there is an exact match or a correspondence, the domain name of the page that was loaded is compared to the domain name associated with the corresponding reference signature. If the domain names do not match, the site is identified as a phishing website.

### Illustrative Network Device

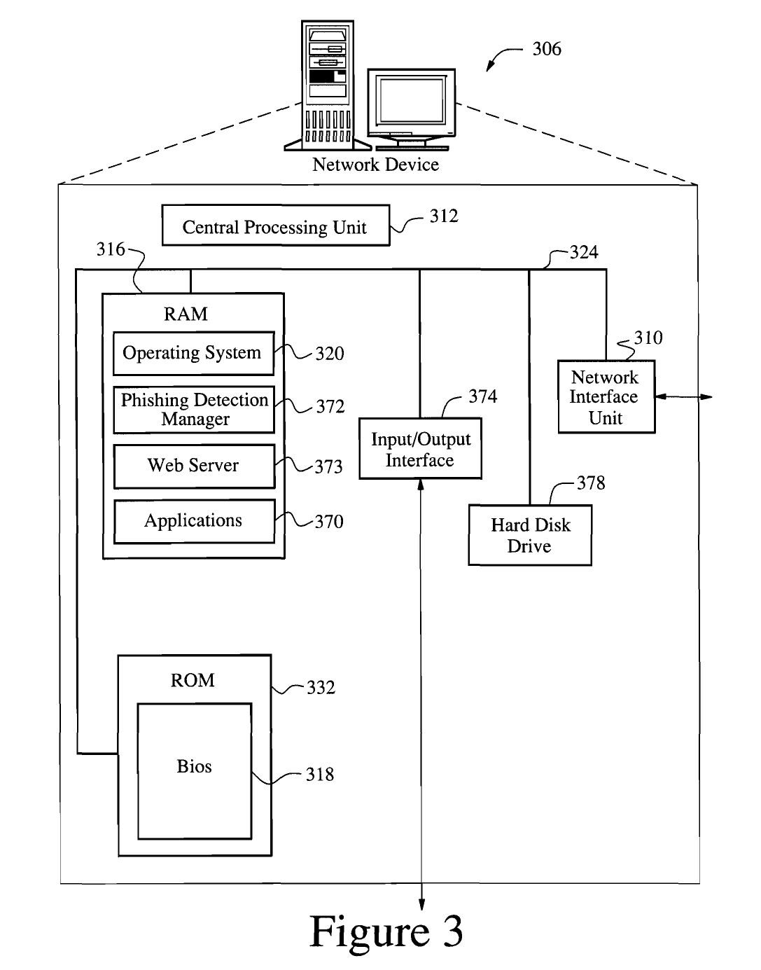

FIG. 3 shows one embodiment of network device 300, according to one embodiment of the invention. Network device 300 may be employed as an embodiment of phishing detection server 106 of FIG. 1, content server 107 of FIG. 1, and/or the like. Network device 300 may include many more components than those shown. The components shown, however, are sufficient to disclose an illustrative embodiment for practicing the invention.

Network device 300 includes processing unit 312, and a mass memory, all in communication with each other via bus 322. The mass memory generally includes RAM 316, ROM 332, and one or more permanent mass storage devices, such as hard disk drive 378, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, such as network 105 in FIG. 1, via network interface unit 310, which is constructed for use with various communication protocols including the TCP/IP protocol. Network interface unit 310 is sometimes known as a transceiver, transceiving device, network interface card (NIC), and the like.

Network device 300 also includes input/output interface 374 for communicating with external devices, such as a mouse, keyboard, scanner, or other input devices not shown in FIG. 3. Likewise, network device 300 may further include additional mass storage facilities such as a CD-ROM/DVD-ROM drive and hard disk drive 378. Hard disk drive 378 is utilized by network device 300 to store, among other things, application programs, databases, and the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 370 are loaded into mass memory and run on operating system 320. Examples of application programs include email programs, schedulers, calendars, transcoders, database programs, word processing programs, spreadsheet programs, and so forth.

One embodiment of network device 300 includes web server 373 and does not include Phishing Detection Manager (PDM) 372. One embodiment of network device 300 includes PDM 372 and does not include web server 373. One embodiment of network device 300 includes both PDM 372 and web server 373.

Web server 373 may store web pages and the like. Web server 373 may also include an HTTP handler application for receiving and handing HTTP requests, and an HTTPS handler application for handling secure connections. The HTTPS handler application may initiate communication with an external application in a secure fashion. Web server 373 may also include an SMTP handler application for transmitting and receiving email.

In one embodiment, PDM 372 provides reference images to client device 200 of FIG. 2. Reference images can be either distributed with a client install or updated incrementally from a server or other source. Also, in one embodiment, client device 200 to send the snapshot image of the page being scanned to PDM 372 or other source for review. In this embodiment, PDM 372 receives the snapshot image, and performs the phishing detection described above rather than at the client.

In one embodiment, PDM 372 determines with there is a URL link in an email sent to the client. If so, the PDM 372 pulls the URL and visually renders the webpage. At this point, image recognition is performed on the visually rendered webpage as described above. If the webpage is identified as counterfeit, the email server may provide a warning message and/or disable the link. Accordingly, in this embodiment, the server may determine whether URL links in the email are counterfeit automatically without any person actually looking at the webpage.

In one embodiment, the list of known phishing websites is also included with any updates to the client, enabling the client to make immediate determinations of websites by matching the URL with an element in the list. Thus adding an additional layer of protection, and avoiding the need to waste other clients' time with image recognition on a known phishing site.

### Illustrative Web Page

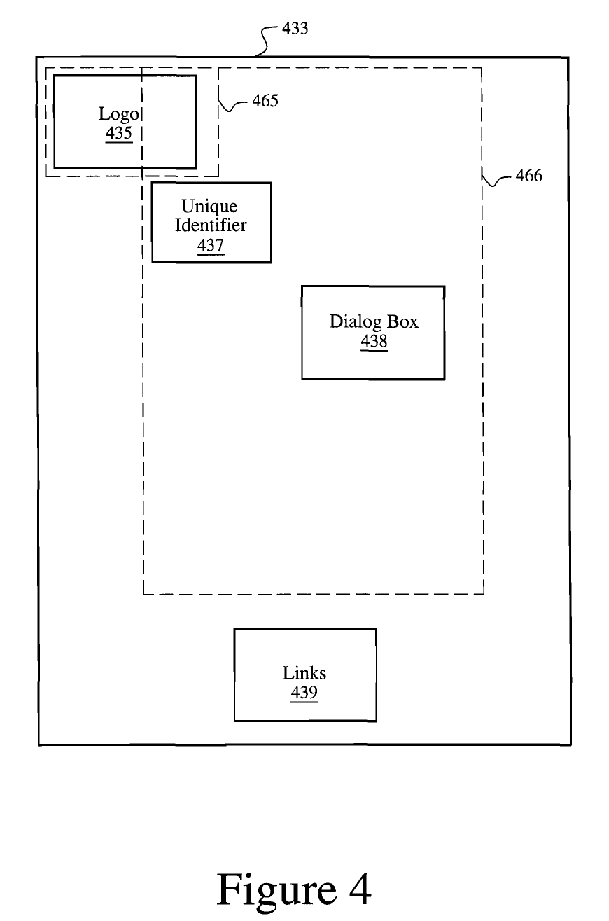

FIG. 4 illustrates an embodiment of a web page 433 that may be subject to phishing detection according to one embodiment of the invention. Web page 433 may be loaded from a browser such as browser 246 of FIG. 2, retrieved from a web server such as web server 373 of FIG. 3. Web page 433 may include components such as logo 435, unique identifier 437, dialog box 438, and links 439. A web page may have more or less components than illustrated in the simplified web page illustrated in FIG. 4.

In various embodiments, various parts of the web page may be used for image recognition algorithms. In one embodiment, the entire web page 433 may be used. In another embodiment, a snapshot may be taken of logo 435 may be used, as shown by box 465. Another snapshot is illustrated by box 466.

In one embodiment, the upper left corner of the page is captured. In another embodiment, logos (e.g. logo 435) or uniquely identifiable graphics (e.g. unique identifier 437), or other graphic indicators may be captured, and the portion of the web page used need not be contiguous. For example, in one embodiment, the snapshot includes all of the visually interesting parts of the page, and not the white space in between. The snapshot may also include non-visual space, such as scroll bars.

### Illustrative Operation

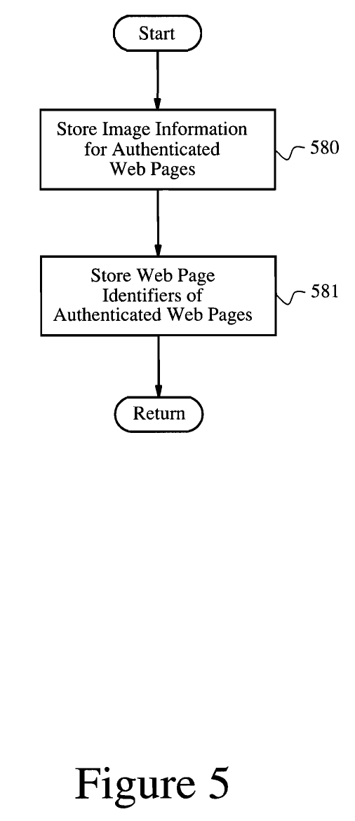

FIG. 5 illustrates a flowchart of an embodiment of process 500, which may be performed by client device 200 of FIG. 2, PDS 106 of FIG. 1, and/or the like.

After a start block, the process moves to block 580, where image information for authenticated web pages is stored for future reference. The process then advances to block 581, where web page identifiers of authenticated web pages are stored for future reference. The process then proceeds to a return block, where other processing is resumed.

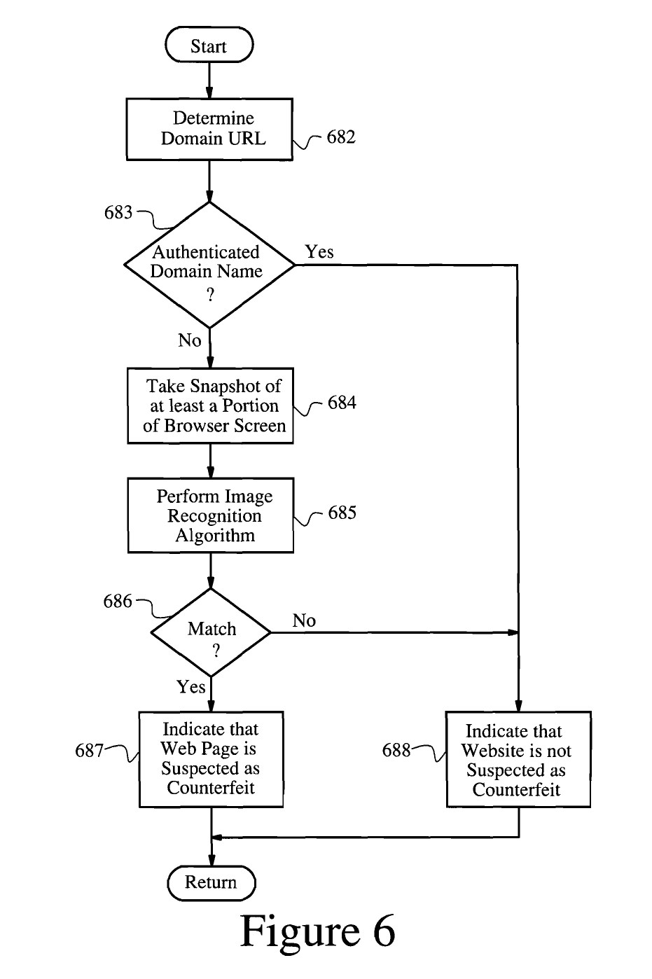

FIG. 6 shows a flowchart of an embodiment of process 600, which may be performed by client device 200 of FIG. 2, PDS 106 of FIG. 1, and/or the like.

After a start block, the process moves to block 682, where the domain name of a web page loaded by a browser is determined. In one embodiment, the domain name is determined by parsing the URL. The process then advances to decision block 683, where a determination is made as to whether the domain name is one of the authenticated domain names. If not, the process proceeds to block 684, where a snapshot is taken of at least a portion of the browser screen. The process then moves to block 685, where an image recognition algorithm is performed.

The process then advances to decision block 686, where a determination is made as to whether the snapshot corresponds to stored image information for authenticated web pages. If so, the process proceeds to block 687, where an indication is made that the web page is suspected as counterfeit (e.g. phishing). The process then moves to a return block, where other processing is performed.

At decision block 686, if the snapshot does not correspond to the stored image information, the process proceeds to block 688, where an indication is made that the website is not suspected as counterfeit. The process then advances to the return block.

At decision block 683, if the domain name of the web page loaded by the browser is one of the authenticated domain names, the process moves to block 688.

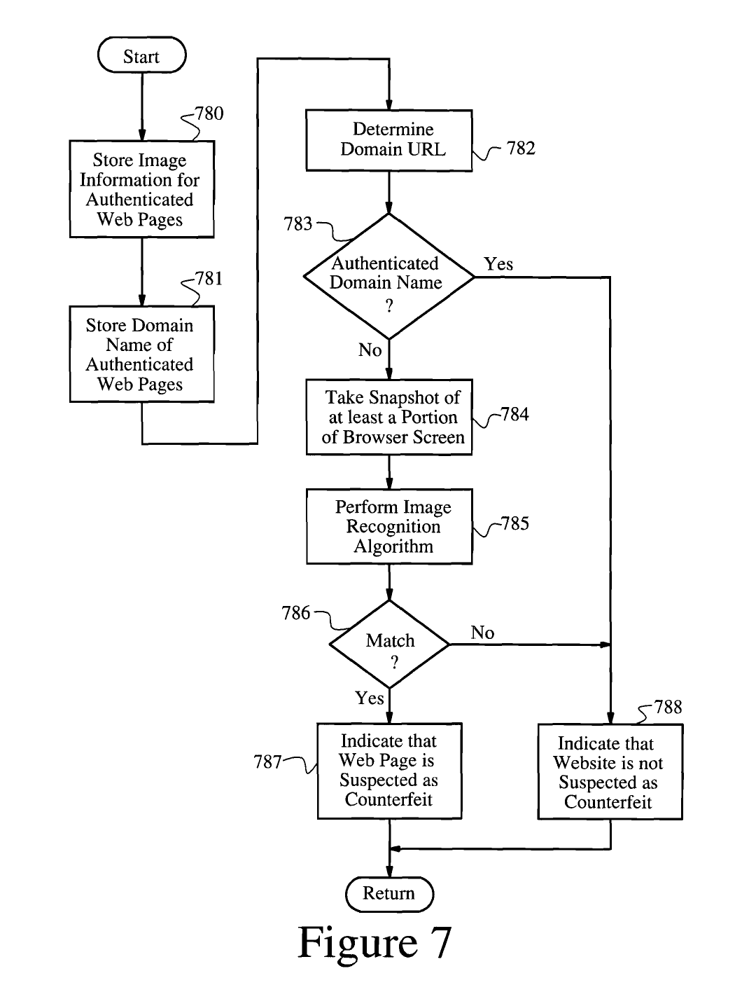

FIG. 7 illustrates a flowchart of an embodiment of process 700.

After a start block, the process moves to block 780, where image information for authenticated web pages is stored. The process then advances to block 781, where the domain names of authenticated web pages are stored. The process then proceeds to block 782, where the domain name of a web page loaded by a browser is determined. In one embodiment, it is determined by parsing the URL. The process then advances to decision block 783, where a determination is made as to whether the domain name is one of the authenticated domain names. If not, the process proceeds to block 784, where a snapshot is taken of at least a portion of the browser screen. The process then moves to block 785, where an image recognition algorithm is performed.

The process then advances to decision block 786, where a determination is made as to whether the snapshot corresponds to stored image information for authenticated web pages. If so, the process proceeds to block 787, where an indication is made that the web page is suspected as counterfeit (e.g. phishing). The process then moves to a return block, where other processing is performed.

At decision block 786, if the snapshot does not correspond to the stored image information, the process proceeds to block 788, where an indication is made that the website is not suspected as counterfeit. The process then advances to the return block.

At decision block 783, if the domain name of the web page loaded by the browser is one of the authenticated domain names, the process moves to block 788.

The above specification, examples, and data provide a complete description of the manufacture and use of the composition of the invention. Since many embodiments of the invention can be made without departing from the spirit and scope of the invention, the invention also resides in the claims hereinafter appended.

1. A method for identifying a counterfeit web page, comprising:
storing image information based on at least one image of at least a portion of a first web page that is authenticated;
storing at least one web page identifier that is authenticated for the stored image information;
comparing at least one image of at least a portion of a second web page to the stored image information; and
if both: the image for the second web page corresponds to the stored image information for the first web page, and a web page identifier of the second web page is unauthentic for the stored image information: providing an indication that the second web page is unauthentic.

2. The method of claim 1, wherein each of the web page identifiers is a domain name.

3. The method of claim 1, further comprising,
storing a list of unauthentic web sites;
if the web page identifier of the second web page is included in the list of authentic web sites, providing an indication that the second web page is authentic;
if the image for the second web page corresponds to the stored image information for the first web page, and the web page identifier of the second web page is unauthentic for the stored image information:
adding the web page identifier of the second web page to the stored list of unauthentic web sites.

4. The method of claim 1, wherein
the stored image information is at least one of a logo, a unique image, or a section of the first web page;
comparing the at least one image of at least a portion of the second web page to the stored image information includes:
taking at least one image snapshot of at least a portion of a browser screen of a browser that has loaded the second web page, wherein the image snapshot is a snapshot of the entire second web page, or an image snapshot of a sampling of image areas of the web page; and
scanning the at least one image snapshot to determine whether the at least one image snapshot includes one of the at least one stored image.

5. The method of claim 1, wherein the at least one web page identifier that is authenticated for the stored image information includes at least the domain name of the first web page, and wherein the web page identifier of the second web page is the domain name of the second web page.

6. The method of claim 1, wherein
the stored image information includes a reference signature, wherein the reference signature is generated based on characters captured from a portion of the first web page; and
wherein comparing the at least one image of at least a portion of the second web page to the at least one stored imagine includes:
taking an image snapshot of a portion of a browser screen of a browser that has loaded the second web page;
employing an optical character recognition algorithm to extract character from the portion of the browser screen;
calculating a signature based on the characters extracted from the portion of the browser screen; and
comparing the signature with the reference signature.

7. The method of claim 6, wherein the portion of the browser screen is the upper left portion of the browser screen.

8. The method of claim 1, wherein comparing the at least one image of the second web page to the stored image information is accomplished by employing an image recognition algorithm.

9. The method of claim 8, wherein the image recognition algorithm includes at least one of a logo recognition algorithm, an optical character recognition algorithm, or an image similarity algorithm.

10. The method of claim 8, wherein the image recognition algorithm is based on an aggregate score of at least two of: a logo recognition algorithm, an optical character recognition algorithm, or an image similarity algorithm.

11. A network device for identifying counterfeit web pages, comprising:
a memory component for storing data; and
a processing component that is arranged to execute data that enables actions, including:
storing image information based on at least one image of at least a portion of a first web page that is authenticated;
storing at least one web page identifier that is authenticated for the stored image information;
comparing at least one image of at least a portion of a second web page to the stored image information; and
if the image for the second web page corresponds to the stored image information for the first web page, and a web page identifier of the second web page is not authenticated for the stored image information:
providing an indication that the second web page is unauthentic.

12. The network device of claim 11, wherein the processing component is arranged to enable comparing the at least one image of the second web page to the stored image information by enabling employing an image recognition algorithm to perform the comparison.

13. The network device of claim 12, wherein the processing component is arranged such that image recognition algorithm includes at least one of a logo recognition algorithm, an optical character recognition algorithm, or an image similarity algorithm.

14. A processor-readable medium having processor-executable code stored therein, which when executed by one or more processors, enables actions, comprising:
storing image information based on at least one image of at least a portion of a first web page that is authenticated;
storing at least one web page identifier that is authenticated for the stored image information;
comparing at least one image of at least a portion of a second web page to the stored image information; and
if the image for the second web page corresponds to the stored image information for the first web page, and a web page identifier of the second web page is not authenticated for the stored image information:
providing an indication that the second web page is unauthentic.

15. The processor-readable medium of claim 14, wherein comparing the at least one image of the second web page to the stored image information is accomplished by employing an image recognition algorithm.

16. The processor-readable medium of claim 15, wherein the image recognition algorithm includes at least one of a logo recognition algorithm, an optical character recognition algorithm, or an image similarity algorithm.

17. The network device of claim 11, wherein the network device is a mobile device.

18. A system for communicating over a network for identifying counterfeit web pages, comprising:
a client device and a system device, wherein the client device and system device are arranged to communicate over a network, and to operate in conjunction with each other to perform actions, including:
storing image information based on at least one image of at least a portion of a first web page that is authenticated;
storing at least one web page identifier that is authenticated for the stored image information;
comparing at least one image of at least a portion of a second web page to the stored image information; and
if the image for the second web page corresponds to the stored image information for the first web page, and a web page identifier of the second web page is not authenticated for the stored image information:
providing an indication that the second web page is unauthentic.

19. The system of claim 18, wherein comparing the at least one image of the second web page to the stored image information is accomplished by employing an image recognition algorithm.

20. The system of claim 19, wherein the image recognition algorithm includes at least one of a logo recognition algorithm, an optical character recognition algorithm, or an image similarity algorithm.

21. A method for identifying a counterfeit web page, comprising:
storing image information for a plurality of authenticated web pages, wherein the image information for each authenticated web page is based on an image of at least a portion of the authenticated web page as it is displayed on a screen;
for each of the authenticated web pages, storing at least one domain name that is authenticated for the authenticated web page; and
if an indication to perform image recognition is provided:
performing an image recognition algorithm to compare the at least one image of at least a portion of a second web page to the images of at least a portion of each of the plurality of authenticated web pages; and
if the image of at least a portion of the second web page corresponds to the at least a portion of at least one of the authenticated web pages, and the domain name for the second web page is not authenticated for the second web page:
providing an indication that the second web page is unauthentic.

22. The method of claim 21, wherein the image recognition algorithm includes at least one of a logo recognition algorithm, an optical character recognition algorithm, or an image similarity algorithm.

23. The method of claim 21, further comprising
providing the indication to perform image recognition if a browser loads a web page, and the domain name of the web page is not included in the stored domain names for each of the authenticated web pages;
if the domain name is included in the stored domain names, providing an indication that the web page is authentic; and
if the image of at least a portion of the second web page is not relatively equivalent to the at least a portion of at least one of the authenticated web pages, providing an indication that the web page is authentic.

24. The method of claim 21, wherein
providing the indication to perform image recognition if a browser loads a web page, the domain name of the web page is not included in the stored domain names for each of the authenticated web pages, and the web page includes a dialog box.
